(19) United States
(12) Patent Application Publication
(10) Pub. No.: US 2005/0134584 A1
(43) Pub. Date: Jun. 23, 2005

(54) Method for forming digital objects

(76) Inventor: Dau-Chiuan Yang, Changhua County (TW)

Correspondence Address: BIRCH STEWART KOLASCH & BIRCH, PO BOX 747, FALLS CHURCH, VA, 22040-0747, US

(21) Appl. No.: 10/736,758

(22) Filed: Dec. 17, 2003

(51) Int. Cl. G06T 17/00

(52) U.S. Cl. 345/420

(57) ABSTRACT

A method for forming digital objects includes selecting a first existing object in a graphic space to build a first reference type; selecting a second existing object to build a second reference type; continuing the like process until Nth existing object is selected to build a Nth reference type; building the generation method of the new object based on the generation type of the object to be generated and the first to Nth reference types; finally building the contour shape of the new object based on the generation method and the shape type of the new object. The method can generate new objects intuitively in a simplified way.

### FIELD OF THE INVENTION

The present invention relates to a method for forming digital objects in computer graphics and particularly to a method that employs one or more existing two-dimensional or three-dimensional objects in the computer graphic space as reference objects to generate a new two-dimensional or three-dimensional object.

### BACKGROUND OF THE INVENTION

Employing computer graphics to indicate a product design is well accepted by the general public and industry now. Designers do not have to fabricate molds to make models. Their ideas and concepts can be materialized and visualized by using graphic software on the computer. People for inquiry can see the required product picture through digital equipment.

The method of using computer graphics to build an assembly consisting of two or more basic shaped objects generally is done by extending an existing object in a selected direction. When the objects hit another one, the hitting location is calculated. Coupling with preset binding method for the objects, a new object may be generated to couple these two or more basic shaped objects.

The aforesaid method has a drawback: it has to generate all individual objects in advance, and has to generate individual objects in the direction to be extended, then determine in sequence the coupling method when hitting occurs to perform coupling operation. The generation process is complex. When the number of generation objects is great, the process becomes very complicated and is prone to error.

### SUMMARY OF THE INVENTION

Therefore, the primary object of the present invention is to resolve the aforesaid disadvantages of the conventional method that sequentially determines coupling methods when hitting occurs and performs coupling process thereafter. The present invention provides a novel graphic forming method that can be processed intuitively and simply to rapidly generate new object coupling.

In order to achieve the foregoing object, the method according to the invention selects an existing first object in a graphic space, and based on the space object type of the desired generation object to calculate and build a first reference type. Similarly, select an existing second object to build a second reference type, and so on until selecting a Nth existing object for building the Nth reference type. Then based on the generation type of the desired generation object and the first to Nth reference types to build the generation type of the new object. Finally, based on the generation type and the shape type of the new object to build the contour shape of the new object.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is the process procedures of the method according to the present invention.

FIG. 2 is a schematic view of a selected reference object of an embodiment according to the present invention

FIG. 3 is a schematic view of an embodiment of the present invention in a forming condition.

FIG. 4 is a schematic view of another embodiment of the present invention in a forming condition.

FIG. 5 is a schematic view of a selected reference object of yet another embodiment of the present invention.

FIG. 6 is a schematic view of yet another embodiment of the present invention in a forming condition.

### DETAILED DESCRIPTION OF THE PREFERRED EMBODIMENTS

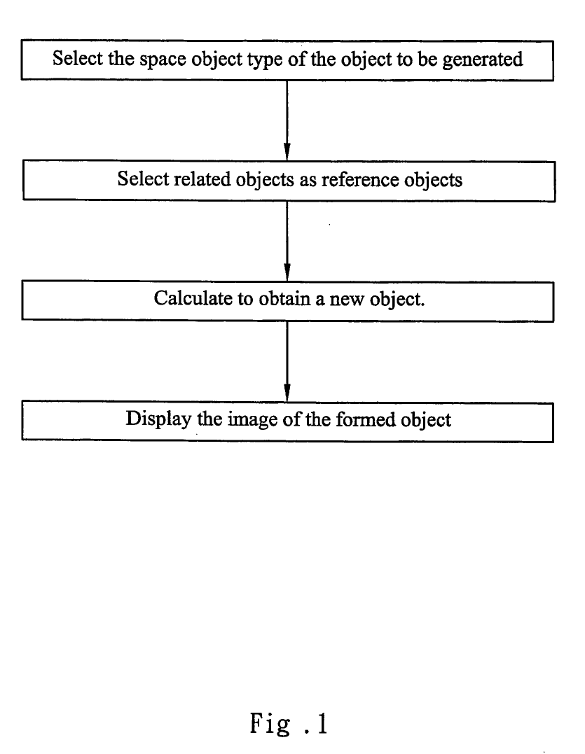

Please refer to FIG. 1 for the method of forming digital objects according to the invention. The method includes the following steps:
a. Selecting a space object type of an object to be generated.
b. Selecting one or more existing blocks related to the object to be generated as reference object.
c. Based on the space object type of the object to be generated and the selected reference object to calculate and generate a new object.

The space object type includes the following items:

One or more reference types: serves as reference for the object to be generated and the selected existing object.

Generation type: sets according to the reference type to dynamically determine the generation method of the space object.

And a shape type: serves as shape description data cluster of the object to be generated.

The calculation is based on the space object type and the one or more existing objects being selected. The first reference type is built by the first selected object, the second reference type is built by the second selected object, and so on until the Nth reference type is built by the Nth selected object. Then based on the first reference type to the Nth reference type, and the generation type to build the generation method of the new object. Finally based on the generation method of the new object and the shape type set forth above to generate the contour shape of the new object.

Details are elaborated as follows by referring to the embodiments:

Embodiment 1: Forming a square pillar object based on two reference objects.

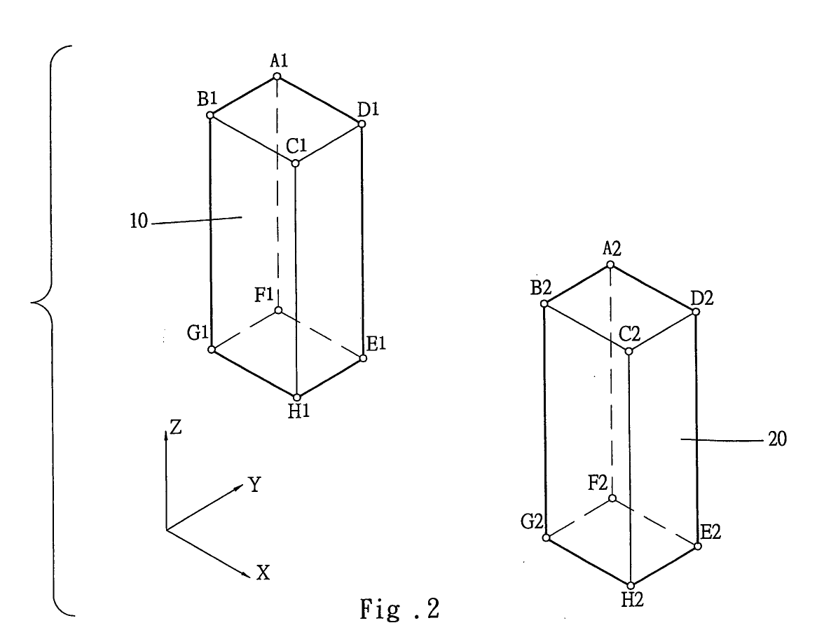

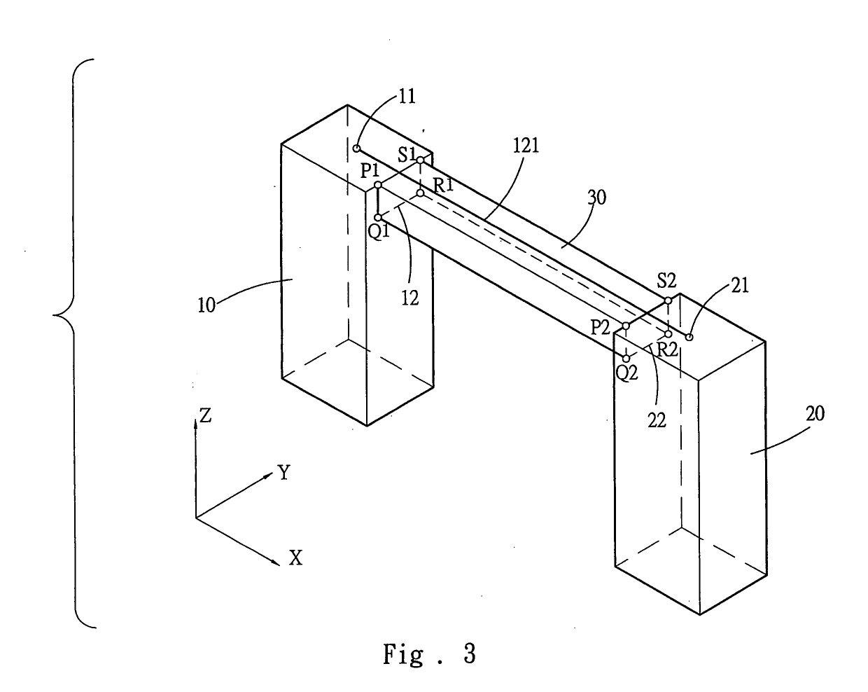

Refer to FIGS. 2 and 3 for the reference objects and a forming embodiment. A new square pillar objects is the object to be generated. The original graphic space already has two existing objects which include a block1 10 and a block2 20 that serve as the reference objects to generate the new square pillar object. The generation process is as follows:

| Block1 10 | Block2 20 |
|---|---|
| Point Coordinates | Point Coordinates |
| A1 (−20.0, 20.0, 300.0) | A2 (380.0, 420.0, 300.0) |
| B1 (−20.0, −20.0, 300.0) | B2 (380.0, 380.0, 300.0) |
| C1 (20.0, −20.0, 300.0) | C2 (420.0, 380.0, 300.0) |
| D1 (20.0, 20.0, 300.0) | D2 (420.0, 420.0, 300.0) |
| E1 (20.0, 20.0, 0.0) | E2 (420.0, 420.0, 0.0) |
| F1 (−20.0, 20.0, 0.0) | F2 (380.0, 420.0, 0.0) |
| G1 (−20.0, −20.0, 0.0) | G2 (380.0, 380.0, 0.0) |
| H1 (20.0, −20.0, 0.0) | H2 (420.0, 380.0, 0.0) |

The space object type of the new object newBlock 30 is described as follows:
Reference type:
   ReferenceObjectSet( )
   ReferenceObject(
      index: Integer,
      selectedObject: ShapeObject,
      targetPartOfSelectedObject: ReferencePart,
      relationship: Relationship)
Embodiment values:
ReferenceObjectSet refObjectSet1
   =new ReferenceObjectSet( );
ReferenceObject refObject11
   =new ReferenceObject(1, block1,
      Block.TOP_FACE_CENTER_POINT, JOINT);
refObjectSet1.add(refObject11);
ReferenceObject refObject12
   =new ReferenceObject(2, block2,
      Block.TOP_FACE_CENTER_POINT, JOINT);
refObjectSet1.add(refObject12);

The foregoing description is to build respectively a first reference object refObject11 and a second reference object refObject 12 based on the setting of the reference types and the selected existing objects block1 10 and block2 20. The first reference object refObject 11 comprises four parameters that include index=1 (1 represents the serial number of the reference object ) selectedObject=block1 (represents the selected existing object 1 (block1)10), targetPartOfSelectedObject=Block.TOP_FACE_CENTER_POINT (represents the generation method of the new object 30 refers to the center point 11 of the top surface of the selected object 1 (block1)10), and relationship=JOINT (represents the new object 30 and the object 1 (block1)10 are coupled by the method of JOINT.

The second reference object refObject12 comprises four parameters that include index=2 (2 represents the serial number of the reference object λ selectedObject=block2 (represents the selected existing object 2 (block2)20), targetPartOfSelectedObject=Block.TOP_FACE_CENTER_POINT (represents the generation method of the new object 30 refers to the center point 21 of the top surface of the selected object 2 (block2)20), and relationship=JOINT (represents the new object 30 and the object 2 (block2)20 are coupled by the method of JOINT).

Then refObject11 and refObject12 are included in refObjectSet1 to build a reference object cluster.

Generation Type:

Generation (targetShapeGeneration: Method,
refObjectSet: ReferenceObjectSet)

Embodiment values:

Generation generation1
=new Generation(Block.TOP_FACE_CENTER_LINE, refObjectSet1);

The generation method (generation1) of the new object 30 is built based on the generation type described above and the aforesaid reference object cluster. The generation method comprises two parameters as follows:
targetShapeGeneration=Block.TOP_FACE_CENTER_LINE (represents that generation of the new object 30 is accomplished by extending along the center line of the top surface of the square pillar of the new object 30), and refObjectSet=refObjectSet1 (represents that the center line of the top surface of the square pillar of the new object refers to the reference object cluster to generate the new object).

Shape type:

Block(width: Double, height: Double,
generation: Generation)

Embodiment values
Block newBlock=new Block(30.0,40.0,generation1)

The new object newBlock is built based on the generation method (generation1) described above and the shape type. The new object (newBlock) 30 comprises three parameters that include width=30.0 (represents the width dimension of the cross section of the square pillar of the new object 30), height=40.0 (represents the height dimension of the cross section of the square pillar of the new object 30), and generation=generation1 (represents the generation type of the square pillar of the new object 30).

Generation process is as follows: Based on the setting of the reference types and the point coordinates record cluster of the existing object 1 (block1) 10 and object 2 (block2) 20, coordinates calculations result in coordinate value of (0.0, 0.0, 300.0) for the center point of the top surface of the object 1 (block1) 10 and coordinate value of (400.0, 0.0, 300.0) for the center point of the top surface of the object 2 (block2) 20.

Based on the settings of the generation type and the foregoing calculated coordinates, generation of the new object (newBlock) 30 is accomplished by extending along a virtual straight line (X=t, 0≦t≦400, Y=0, Z=300).

Based on the parameters refobject11.relationship=JOINT and refObject12.relationship=JOINT of the reference type, and the parameters of width=30.0, height=40.0 in the shape type, and the virtual straight line 121 of the generation method set forth above, and through coordinates calculations, the distal end coordinates of the projecting cross section 12 of the object 1 (block1) 10 are P1 (20.0, −15.0, 300.0), Q1 (20.0, −15.0, 260.0) R1 (20.0, 15.0, 260.0) and S1 (20.0, 15.0, 300.0), and the distal end coordinates of the projecting cross section 22 of the object 2 (block2) 20 are P2 (380.0, −15.0, 300.0), Q2 (380.0, −15.0, 260.0), R2 (380.0, 15.0, 260.0) and S2 (380.0, 15.0, 300.0).

Hence based on the coordinates of eight points P1, Q1, R1, S1, P2, Q2, R2 and S2, the new object (newBlock) 30 may be built.

Embodiment 2: Forming an extended plate object based on two reference objects.

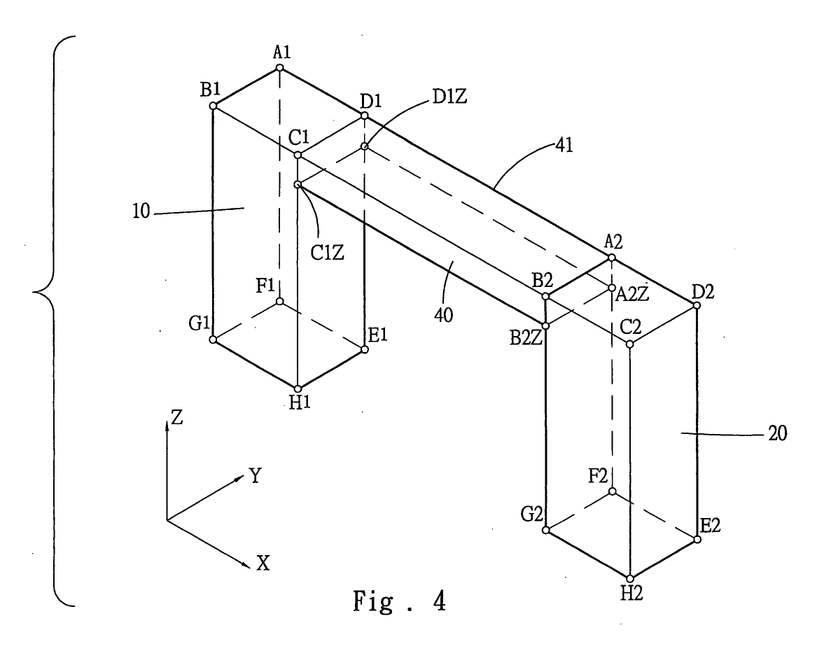

Refer to FIGS. 2 and 4 for the reference objects and a forming embodiment.

As shown in the drawings, there are an object 1 (block1) 10 and an object 1 (block2) 20 as previously discussed. This embodiment aims to form a plate. In the original graphic space the object 1 (block1) 10 and object 2 (block2) 20 already existed. With the object 1 (block1) 10 and object 1 (block2) 20 as reference objects, a new object 40 (a plate object) is to be generated. The generation processing is as follows:

| Block1 - 10 | Block2 - 20 |
|---|---|
| Point Coordinates | Point Coordinates |
| A1 (−20.0, 20.0, 300.0) | A2 (380.0, 420.0, 300.0) |
| B1 (−20.0, −20.0, 300.0) | B2 (380.0, 380.0, 300.0) |
| C1 (20.0, −20.0, 300.0) | C2 (420.0, 380.0, 300.0) |
| D1 (20.0, 20.0, 300.0) | D2 (420.0, 420.0, 300.0) |
| E1 (20.0, 20.0, 0.0) | E2 (420.0, 420.0, 0.0) |
| F1 (−20.0, 20.0, 0.0) | F2 (380.0, 420.0, 0.0) |
| G1 (−20.0, −20.0, 0.0) | G2 (380.0, 380.0, 0.0) |
| H1 (20.0, −20.0, 0.0) | H2 (420.0, 380.0, 0.0) |

The space object type of the new object 40 is described as follows:

Reference Types

ReferenceObjectSet( )

ReferenceObject (index: Integer,
selectedObject: ShapeObject,
targetPartOfSelectedObject: ReferencePart,
relationship: Relationship)

Embodiment values:

ReferenceObjectSet refObjectSet2
=new ReferenceObjectSet( );

ReferenceObject refObject21
=new ReferenceObject(1, block1,
   Block. TOP_FACE_RIGHT_LINE, JOINT);

refObjectSet2.add(refObject21);

ReferenceObject refObject22
=new ReferenceObject(2, block2,
   Block.TOP_FACE_LEFT_LINE, JOINT);

refObjectSet2.add(refObject22);

The foregoing description is to build respectively a first reference object refObject21 and a second reference object refObject 22 based on the setting of the reference types and the selected existing object 1 (block1) 10 and object 2 (block2) 20. The first reference object refObject 21 comprises four parameters that include index=1 (1 represents the serial number of the reference object ) selectedObject=block1 (represents the selected existing object−(block1)10) targetPartOfSelectedObject=Block.TOP_FACE_CENTER_POINT (represents the generation method of the new object 40 refers to a line section C1D1 on the right side of the top surface of the selected object 1 (block1)10), and relationship=JOINT (represents the new object 40 and the object 1 (block1) 10 are coupled by the method of JOINT).

The second reference object refObject12 comprises four parameters that include index=2 (2 represents the serial number of the reference object) selectedObject=block2 (represents the selected existing object2 (block2)20 ), targetPartOfSelectedObject=Block.TOP_FACE_CENTER_POINT (represents the generation method of the new object 40 refers to a line section A2B2 on the left side of the top surface of the selected block2 20 ) and relationship=JOINT (represents the new object 40 and the object2 (block2) 20 are coupled by the method of JOINT).

Then the refObject21 and refObject22 are included in refObjectSet2 to build a reference object cluster.

Generation Type:

Generation (targetShapeGeneration: Method,
refObjectSet: ReferenceObjectSet)

Embodiment values
Generation generation2
=new Generation (Plate.TOP_FACE, refObjectSet2);

The generation method (generation2) of the new object 40 is built based on the generation type described above and the aforesaid reference object cluster. The generation method comprises two parameters as follows:
targetShapeGeneration=Plate.TOP_FACE (represents that generation of the new object 40 is accomplished by extending the top surface of the plate of the new object 40), and refObjectSet=refObjectSet2 (represents that generation of the new object 40 refers to the reference object cluster).

Shape type

Plate (depth: Double, generation: Generation)

Embodiment Values:

Plate newPlate1=new Plate(20.0,generation2)

The new object newPlate1 40 is built based on the shape type and the generation method (generation2) described above. The new object 40 comprises two parameters that include depth=20.0 (represents the thickness dimension of the new object 40), and generation=generation2 (represents the generation type of the new object 40).

Generation process is as follows: Based on the settings of the reference types and the point coordinates record cluster of the object 1 (block1) 10 and object 2 (block2) 20, Block.TOP_FACE_RIGHT_LINE is the straight line between point C1 and D1, i.e. the straight line between the coordinates points C1 (20.0,−20.0,300.0) and D1(20.0,20.0,300.0); Block.TOP_FACE_LEFT_LINE is the straight line between point A2 and point B2, i.e. the straight line between coordinates points A2 (380.0,420.0,300.0) and B2 (380.0,380.0,300.0).

Based on the settings of the generation type and the foregoing

Block.TOP_FACE_RIGHT_LINE and

Block.TOP_FACE_LEFT_LINE, generation of the new object (newPlate1) 40 (a plate object) is accomplished by extending downwards from a virtual plane (Plate.TOP_FACE) 41 formed by points C1, D1, A2 and B2.

Based on the parameters refObject21.relationship=JOINT, and refObject22.relationship=JOINT of the reference types, and the parameters of depth=20.0 in the shape type, and the virtual plane 41 generated by the aforesaid method, the result of coordinates calculations is as follows: C1Z(20.0,−20.0,280.0) D1Z(20.0,20.0,280.0) A2Z(380.0,420.0,280.0) and B2Z(380.0,380.0,280.0).

Then based on the eight coordinate points C1, D1, A2, B2, C1Z, D1Z, A2Z, and B2Z, the new plate object (newplate 1) 40 may be built.

Embodiment 3: Forming a plate based on a single reference object.

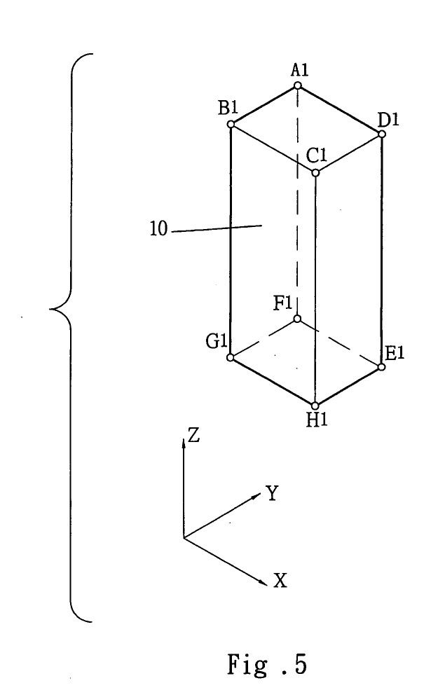

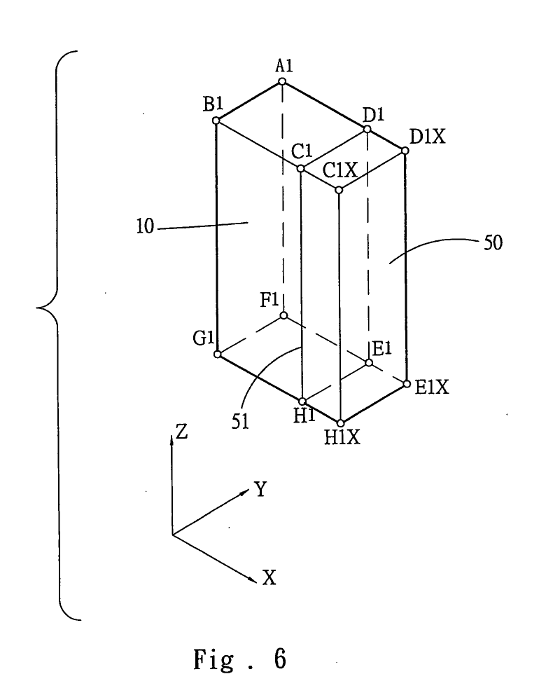

Refer to FIGS. 5 and 6 for the reference object and the forming embodiment. It differs from the previous two embodiments. The original graphic space has only one object 10.

The generation process for forming a new object 50 (plate object) based on the reference object 1 (block1) 10 is as follows:

Block1 - 10
Point Coordinates

A1 (−20.0, 20.0, 300.0)
B1 (−20.0, −20.0, 300.0)
C1 (20.0, −20.0, 300.0)
D1 (20.0, 20.0, 300.0)
E1 (20.0, 20.0, 0.0)
F1 (−20.0, 20.0, 0.0)
G1 (−20.0, −20.0, 0.0)
H1 (20.0, −20.0, 0.0)

The space object type of the new object 50 is described as follows:

Reference Types
ReferenceObjectSet( )
ReferenceObject (index: Integer,
   selectedObject: ShapeObject,
   targetPartOfSelectedObject: ReferencePart,
   relationship : Relationship)

Embodiment Values:

ReferenceObjectSet refObjectSet3
=new ReferenceObjectSet( );

ReferenceObject refObject31
=new ReferenceObject(1, block1, Block.RIGHT_FACE,
   JOINT);
refObjectSet3.add(refObject31);

The foregoing description is to build a first reference object refObject31 based on the settings of the reference types and the selected existing object 1 (block1) 10. The first reference object refObject 31 comprises four parameters that include index=1 (1 represents the serial number of the reference object ) selectedObject=block1 (represents the selected existing object1−(block1)10), targetPartOfSelectedObject=Block.RIGHT_FACE (represents the generation method of the new object 50 refers to a right side plane C1D1E1H1 of the selected object1 (block1)10) and relationship=JOINT ( represents the new object 50 and the object1 (block1) 10 are coupled by the method of JOINT).

Then refObject31 is included in the object cluster refObjectSet3 to build a reference object cluster.

Generation Type:

Generation(targetShapeGeneration: Method, refObjectSet: ReferenceObjectSet)

Embodiment values:

Generation generation3
=new Generation(Plate.LEFT_FACE, refObjectSet3);

The generation method (generation3) of the new object is built based on the generation type described above and the aforesaid reference object cluster. The generation method (generation3) comprises two parameters as follows:

targetShapeGeneration=Plate.LEFT_FACE (represents that generation of the new object 50 is accomplished by extending the left side surface of the plate of the new object 50), and refObjectSet=refObjectSet3 (represents that generation of the new object 50 refers to the reference object cluster).

Shape type:

Plate (depth: Double, generation: Generation)

Embodiment Values:

Plate newPlate2=new Plate(20.0,generation3)

The new object new 50 is built based on the shape type and generation method described above. The new object 50 comprises two parameters that include depth=20.0 (represents the thickness dimension of the new object 50), and generation=generation3 (represents the generation type of the new object 50).

Generation process is as follows: Based on the settings of the reference type and the point coordinates record cluster of the existing object 1 (block1) 10, Block._RIGHT_FACEE is a plane formed by four coordinates points C1 (20.0,−20.0,300.0), D1 (20.0,20.0,300.0), E1 (20.0,20.0,0.0) and H1 (20.0,−20.0,0.0).

Based on the settings of the generation type and the foregoing Block.RIGHT_FACE, the new object 50 (newPlate2) may be generated by extending rightwards of the virtual plane (Plate.LEFT_FACE) 51 formed by C1 (20.0,−20.0,300.0), D1 (20.0,20.0,300.0), E1 (20.0,20.0,0.0) and H1 (20.0,−20.0,0.0). Based on the parameter refObject31.relationship=JOINT of the reference type and parameter depth=20.0 of the shape type, and the virtual plane 51 calculated by the foregoing generation method, the results of coordinates calculations are: C1X(40.0,−20.0,300.0) D1X(40.0,20.0,300.0) E1X(40.0,20.0,0.0) and H1X(40.0,−20.0,0.0)

Then based on the eight coordinate points C1, D1, E1, H1, C1X, D1X, E1X and H1X, the new object 50 (plate object newPlate2) may be built.

1. A method for forming digital objects in computer graphics to rapidly generate two-dimensional and three-dimensional objects, comprising steps of:
a. selecting a space object type of a new object to be generated;
b. selecting one or more existing object related to the new object as a reference object;
c. calculating and generating the new object based on the space object type of the new object and the selected reference object.

2. The method of claim 1, wherein the space object type includes:
one or more reference types for establishing reference relationship between the new object to be generated and the selected existing object;
a generation type set according to the reference type to dynamically determine the generation method of the space object; and
a shape type being a shape description cluster to represent the new object to be generated.

3. The method of claim 1, wherein the calculation is based on the reference relationship between the space object type and the one or more selected existing reference objects to build the new object.
